(19) United States
(12) Patent Application Publication
(10) Pub. No.: US 2004/0245920 A1
(43) Pub. Date: Dec. 9, 2004

(54) Organic electroluminescence display element, a display device and a method for producing each

(75) Inventor: Nobuhiro Nakamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: OPTREX Corporation, Tokyo (JP)

(21) Appl. No.: 10/828,416

(22) Filed: Apr. 21, 2004

Related U.S. Application Data
(63) Continuation of application No. PCT/JP03/04630, filed on Apr. 11, 2003.

(30) Foreign Application Priority Data
Apr. 11, 2002 (JP) 2002-109682
Aug. 30, 2002 (JP) 2002-252296

(51) Int. Cl. H05B 33/00

(52) U.S. Cl. 313/504; 313/503; 313/506

(57) ABSTRACT

An organic EL display element having an anode, a driving circuit connecting terminal, a cathode and a cathode supplementary wire having a low resistance, a low contact resistance to the cathode and the driving circuit connecting terminal and having reliable contact characteristics wherein the cathode supplementary wire is disposed between the driving circuit connecting terminal and the cathode and has a surface layer composed of Mo or a Mo alloy, is presented.

### TECHNICAL FIELD

The present invention relates to an organic electroluminescence (organic EL) display element as a display element using an organic light emitting material and an organic electroluminescence (organic EL) display device as a display device using such element.

### BACKGROUND ART

In a rapid progress of technological development in an information-communication field in recent years, there is much expectation of a flat display device instead of CRT. In particular, intensive studies have been made with respect to an organic EL display because it is excellent in quick response, visibility, luminance and so on.

The organic EL element announced by Tang el al. of Eastman Kodak U.S.A. in 1987 has a two-layered lamination structure of thin organic films wherein tris(8-quinolinolato)aluminum (hereinbelow, abbreviated as “Alq”) is used as a light emitting layer. When this element was driven by a low voltage such as not more than 10V, a green light was emitted and a high luminance as 1000 cd/m² could be obtained. The luminous efficiency was 1.5 lumen/W (Appl. Phys. Lett., 51, 913 (1987)).

Subsequently, research has been made rapidly for practical applications, and various lamination type organic EL elements comprising one organic layer to about ten organic layers which are sandwiched by a hole injection electrode and an electron injection electrode, have been developed.

With respect to an organic EL material too, methods for forming various kinds of low molecular compounds into a thin film by, for example, a vacuum deposition method or methods for forming a high molecular compound into a thin film by a spin coat method, an ink jet method, dye coat method, flexographic printing method have been proposed to prepare an organic EL element.

In the homepage of the Japanese Patent Office, technical information relating to the organic EL element prepared by “technical-field-discriminated patent map preparing committee” is seen in which a technical report is made by referring application publications of patents and registered patents with respect to so-called basic patents, various kinds of materials, methods, device structures, driving methods, colorizing techniques, durability, methods of use and so on.

In organic EL display devices, a current driving element is used, and in passive driving type organic EL display devices, instantaneous emission of light is required in a time in which each row is selected. As a result, a large current flows into the electrodes in comparison with a case that a voltage driving type display element such as a liquid crystal device is used.

For example, when a panel having a pixel size of 300 μm×300 μm and 100 anodes is driven at a duty ratio of 1/64, the current flowing into a cathode in a selection period reaches 172.8 mA under conditions that the luminous efficiency is 1 cd/A and the average luminance is 300 cd/m². On the other hand, when a liquid crystal display device using a voltage driving element is used, there is no case that such an excessively large current flows.

In consideration of this, there is adopted a structure that a cathode supplementary wire having a low resistance is connected between a cathode and a driving circuit connecting terminal in order to suppress a voltage increase due to the current flowing there whereby the current flows to the driving circuit connecting terminal through the cathode supplementary wire.

However, with demands to increase the size, precision and luminance of the panel, there are problems that further lowering of the resistance of the cathode supplementary wire is required, and at the same time, lowering of the resistance of a contact portion between the cathode and the cathode supplementary wire and a contact portion between the driving circuit connecting terminal and the cathode supplementary wire are required.

In particular, it is necessary for the contact characteristics of the cathode to the cathode supplementary wire to have not only low resistance characteristics but also being stable against the Joule heat generated at the contact portions depending on the magnitude of an electric current flowing there. Namely, it is required to prevent the contact resistance by the Joule heat from increasing, and more severe contact performance is required. The increase of the contact resistance by the Joule heat is considered to be due to the oxidation of the metal used for the supplementary wire or the like.

FIG. 8 shows the structure of contact between a cathode and a cathode supplementary wire according to a conventional technique. In FIG. 8, an anode 2a and a driving circuit connecting terminal 2b are formed on a transparent substrate 1 made of glass or the like.

The driving circuit connecting terminal 2b is connected electrically to a cathode 7 via a cathode supplementary wire 3. By supplying an electric current between the anode 2a and the cathode 7, an organic EL layer 6 emits light. An insulation film 4 serves to define a portion 4a where the organic EL layer 6 contacts the anode 2a.

In such structure, generally, ITO (indium oxide-tin oxide) is used for the anode 2a, and an easily oxidizable metal such as Al, Mg, Ag or the like is used for the cathode. Metal such as Cr or the like is used for the cathode supplementary wire.

In this case, for instance, when a patterned Cr having a film thickness of 300 nm, a width of 150 μm, a length of 4 mm and a specific resistance of 20 μΩ cm is used for the supplementary wire, the resistance is 17.7 Ω. When the above-mentioned current is supplied, a voltage drop of about 3.1 V takes place in response to the resistance of the wire, whereby there is an increase of voltage beyond the predetermined electric potential.

Further, as shown in FIG. 8, an oxidized layer 3a is formed on the cathode supplementary wire 3 in manufacturing processes, with the result that the contact resistance between the cathode 7 and the cathode supplementary wire 3 increases.

Then, the voltage rise seems to cause adverse effects such as an uneven display at the time of gradation display and a rise of withstand voltage of an anode driver used.

In connection with this, for instance, JP-A-11-317292 (a prior art document 1) discloses a technique concerning a cathode supplementary wire in an organic EL display element. In the prior art document 1, a transparent electrode material is used for a driving circuit connecting terminal, and the same material is used for a cathode and a cathode supplementary wire. In this case, there is a large possibility of eliminating the problem of the contact resistance between the cathode and the cathode supplementary wire unless surfaces of the cathode and the cathode supplementary wire are oxidized before connecting the cathode to the cathode supplementary wire.

However, an easily oxidizable material is generally used for the cathode of an organic EL display element, and on the other hand, a metal oxide such as ITO is used for the transparent electrode.

Therefore, when the cathode supplementary wire and the cathode are made of the same material, there occurs a problem that the metal constituting the cathode supplementary wire is oxidized at the contact portion between the cathode supplementary wire and the driving circuit connecting terminal for which a transparent electrode material is used, during the manufacturing of the organic EL display element and in use of it, whereby the contact resistance increases.

In particular, the increase of the contact resistance is remarkable when it is kept at a high temperature. When Al or an Al alloy is used for the cathode and the cathode supplementary wire, and ITO is used for the driving circuit connecting terminal, the contact resistance increases remarkably when it is kept at about 100° C.

JP-A-11-329750 (prior art document 2) discloses a technique of reducing the contact resistance between a cathode and a cathode supplementary wire. The prior art document 2 describes that low-resistance contact characteristics can be obtained by forming a cathode supplementary wire into two portions of an undercoat pattern and an electrode pattern, and TiN or Cr is used for the undercoat pattern and Al is used for the electrode pattern to be in contact with the cathode.

However, this technique has a problem of productivity before discussing the problem of reducing the contact resistance because it is necessary to carry out a photolithographic process twice in order to form the cathode supplementary wire, and it is necessary to apply dry etching for the patterning of TiN.

Further, in the case of using Cr for the undercoat pattern, the contact resistance may increase remarkably if it is left at a high temperature of about 100° C. even though the initial contact characteristics are good. Accordingly, there remains a problem of reliability.

Further, JP-A-2001-351778 (prior art document 3) discloses an organic electroluminescence display element to solve the problem of the increase of the contact resistance of a metal electrode during baking in manufacturing. For this, a barrier layer is formed on the surface layer of a circuitous electrode provided on a transparent substrate, and the circuitous electrode is brought into contact with a metal electrode 4 via the barrier layer wherein the metal electrode 4 is laminated on the transparent substrate via an organic light emitting layer.

The circuitous electrode is made of a conductive metallic material such as Cr, Al, Cu, Ag, Au, Pt, Pd, Ni, Mo, Ta, Ti, W, C, Fe, In, Ag—Mn, Zn or the like. The barrier layer is made of a metal having a high melting point and good properties against thermal deterioration, a noble metal, an oxide, a nitride or an oxynitride.

Thus, the prior art document explains that the contact resistance between the circuitous electrode and the metal electrode can be kept low even by heating in the formation of the interlayer insulation film, and therefore, the driving is possible with a low voltage. Further, if the circuitous electrode is formed by interposing a contact improving layer, the contact of the circuitous electrode to the transparent substrate is improved whereby good contacting state can be maintained between the circuitous electrode and the metal electrode. In the conventional document 3, the electrode structure using Cr is shown. However, a concrete example of the electrode structure using Mo is not described.

### DISCLOSURE OF THE INVENTION

It is an object of the present invention to provide an organic EL display element provided with a cathode supplementary wire wherein it has a low resistance, in particular, a low resistance from the beginning of use, it can be of a low contact resistance with respect to a cathode and a driving circuit connecting terminal, and has reliable contact characteristics; an organic EL display device using the display element, and a method for producing the organic EL display element.

In accordance with Embodiment 1 of the present invention, there is provided an organic electroluminescence display element comprising a first conductive layer, a second conductive layer opposed to the first conductive layer, a driving circuit connecting terminal connected electrically to the first conductive layer via a supplementary wire and an organic electroluminescence layer disposed between the first conductive layer and the second conductive layer, wherein the supplementary wire has at least one surface layer as a layer containing Mo or a Mo alloy.

According to Embodiment 2 of the present invention, there is provided the organic electroluminescence display element according to Embodiment 1, wherein the first conductive layer is connected to the layer containing Mo or a Mo alloy.

According to Embodiment 3, there is provided the organic electroluminescence display element according to Embodiment 1 or 2, wherein the second conductive layer is made of ITO.

According to Embodiment 4, there is provided the organic electroluminescence display element according to Embodiment 1, 2 or 3, wherein the supplementary wire has a layer made of Al, an Al alloy, Ag or an Ag alloy.

According to Embodiment 5, there is provided the organic electroluminescence display element according to Embodiment 1, 2, 3 or 4, wherein the first conductive layer is connected to an etched surface of the layer containing Mo or a Mo alloy.

According to Embodiment 6, there is provided the organic electroluminescence display element according to Embodiment 1, 2, 3, 4 or 5, wherein the portion connected to the layer containing Mo or a Mo alloy, of the first conductive layer is defined by an insulation film.

According to Embodiment 7, there is provided the organic electroluminescence display element according to any one of Embodiments 1 to 6, wherein the Mo alloy contains Nb.

According to Embodiment 8, there is provided the organic electroluminescence display element according to Embodiment 7, wherein the content of Nb in the Mo alloy is 5 to 20 atomic %.

According to Embodiment 9, there is provided the organic electroluminescence display element according to any one of Embodiments 1 to 8, wherein the number of supplementary wires is at least 30.

According to Embodiment 10, there is provided the organic electroluminescence display element according to any one of Embodiments 1 to 9, wherein the portion connected to a supplementary wire, of the first conductive layer contains Al or an Al alloy.

According to Embodiment 11, there is provided an organic electroluminescence display element comprising a first conductive layer, a second conductive layer opposed to the first conductive layer, a driving circuit connecting terminal connected electrically to the first conductive layer via a supplementary wire and an organic electroluminescence layer disposed between the first conductive layer and the second conductive layer, wherein the supplementary wire comprises at least 3 layers including a layer containing Mo or a Mo alloy as a surface layer and a layer containing Al or an Al alloy formed below the surface layer.

According to Embodiment 12, there is provided an organic electroluminescence display device comprising an organic electroluminescence display element described in any one of Embodiments 1 to 11 and a driving circuit for driving the organic electroluminescence display element.

According to Embodiment 13, there is provided a method for producing an organic electroluminescence display element which comprises connecting electrically one of conductive layers formed by interposing an organic electroluminescence layer, to a driving circuit connecting terminal via a supplementary wire, wherein the connecting electrically includes a step of forming a layer containing Mo or a Mo alloy as the surface layer of the supplementary wire connected to the conductive layer and a step of etching the layer containing Mo or a Mo alloy by using gas containing at least CF₄ and oxygen or gas containing at least CF₆ and oxygen.

### BRIEF DESCRIPTION OF THE DRAWINGS

FIG. 1 is a plan view showing Embodiment of the organic EL display element of the present invention.

FIG. 2 is a cross-sectional view taken along A-A′ in FIG. 1.

FIG. 3 is a plan view showing Embodiment of the organic EL display element of the present invention.

FIGS. 4A to 4B are cross-sectional views taken along B-B′ in FIG. 3 and FIG. 4C is a cross-sectional view taken along B-B′ in FIG. 3 of the organic EL display element formed in the same manner as Embodiment 1, in which oxygen plasma irradiation is omitted, in manufacturing processes.

FIG. 5 is a graph showing contact characteristics between a cathode and a cathode supplementary wire of an embodiment of the organic EL display element obtained by the present invention.

FIG. 6 is a graph showing contact characteristics by a conventional technique. FIG. 7 is a graph showing contact characteristics between a cathode and a cathode supplementary wire of another embodiment of the organic EL display element obtained by the present invention.

FIG. 8 is a cross-sectional view showing the contact structure according to a conventional technique.

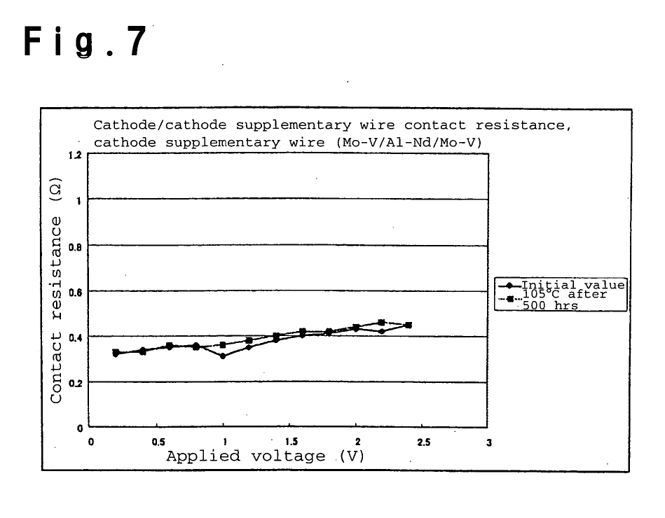

FIG. 9 is a flow chart showing a sequence of preparation of an organic EL display element according to the present invention.

FIG. 10 is a cross-sectional view showing a reverse taper structure.

FIG. 11 is a cross-sectional view showing a state that an anode edge 9 is in contact with an organic EL layer.

### BEST MODE FOR CARRYING OUT THE INVENTION

In the following, some practical embodiments of the present invention will be described with reference to drawings, examples and so on. However, these drawings and description show exemplification of the present invention and they do not limit the scope of the present invention. Of course, another practical embodiment belongs to the present invention as far as it meets the spirit of the present invention.

For example, a structure that the anode and the cathode as described below are exchanged can be adopted. Further, in this description, a case that a lamination film of metal constituting the supplementary wire comprises three layers: a layer containing Mo or a Mo alloy, a layer made of either one of Al, an Al alloy, Ag and an Ag alloy and a layer containing Mo or a Mo alloy, is described. However, the composition of layers containing Mo or a Mo alloy formed at both sides may be different from each other. Further, another metal layer may be placed inside.

In addition, a case of lacking a layer containing Mo or a Mo alloy belongs to the scope of the present invention. For example, when the driving circuit connecting terminal is made of a material which can prevent the layer of Al, an Al alloy, Ag or an Ag alloy from oxidizing and can prevent the contact resistance from increasing, it can be considered to omit the layer containing Mo or a Mo alloy at the side connectable to the driving circuit connecting terminal.

On the contrary, in a manufacturing process to be conducted before the connection to the cathode, if there is a low risk of increasing the contact resistance of the layer made of Al, an Al alloy, Ag or an Ag alloy of the cathode supplementary wire or a material constituting the cathode due to oxidation, it can be considered to omit the layer containing Mo or a Mo alloy at a side connectable to the cathode.

Generally, there are many cases of being easily oxidized even though a strictly controlled process is applied to the layer made of Al, an Al alloy, Ag or an Ag alloy or the material constituting the cathode. Accordingly, the layer containing Mo or a Mo alloy at the side connectable to the cathode is often considered to be more important than the layer containing Mo or a Mo alloy at the side connectable to the driving circuit connecting terminal.

The reason that the supplementary wire has preferably the layer made of Al, an Al alloy, Ag or an Ag alloy is that lowering of the resistance is easy and high reliability is obtainable.

The increase of the contact resistance takes place during manufacturing processes of the organic EL display element or in use of the organic EL display element.

In observation of the increase of the contact resistance of a completed organic EL display element with time, the initial value is a value including an increment of the contact resistance generating in manufacturing processes, and an increment of the contact resistance generating subsequently takes place in use of the display element.

The organic EL display device referred to in the present invention has a general construction including a driving circuit, a driving power source, a casing and accessory devices in addition to the organic EL display element having an anode, a driving circuit connecting terminal, an organic EL layer and a cathode as major components.

In the drawings, the same parts are designated with the same reference numerals.

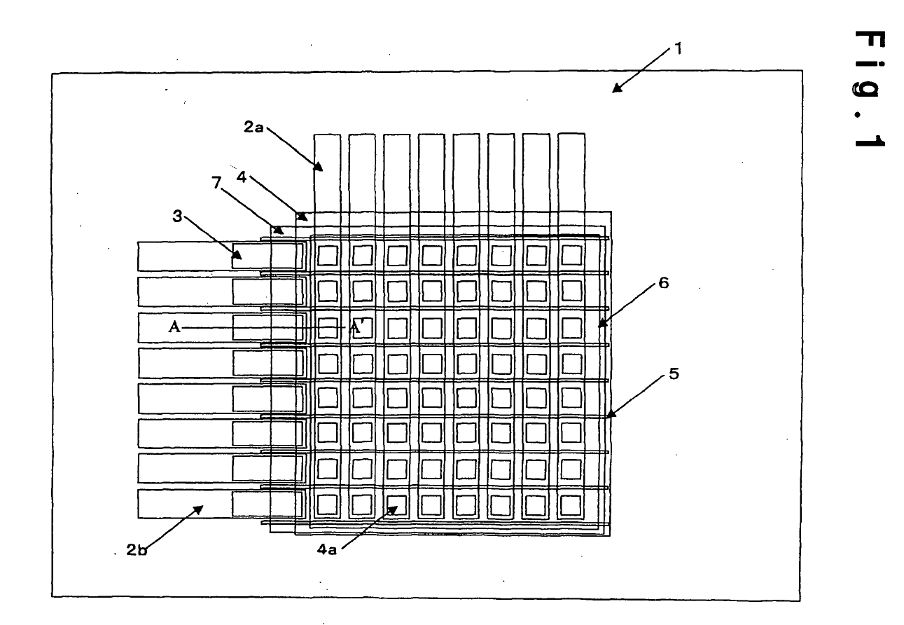

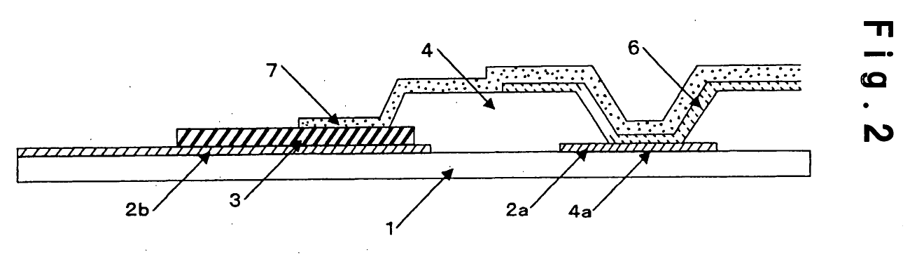

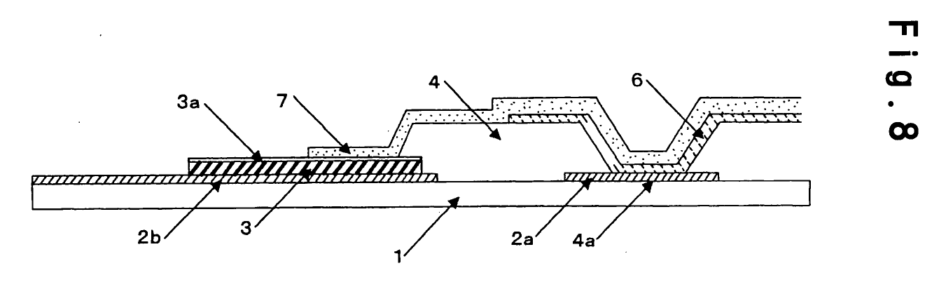

FIG. 1 is a plan view of an embodiment of the organic EL display element of the present invention, and FIG. 2 is a cross-sectional view taken along A-A′ in FIG. 1. FIG. 9 is a flow chart showing a sequence of preparation of the organic EL display element as an example of the present invention.

In the following, description will be made according to the sequence of steps in FIG. 9 with reference to FIGS. 1 and 2.

First, at Step S₁, a conductive layer is formed on a silica coat layer of a glass substrate 1 having the silica coat layer. This conductive layer corresponds to the second electrode layer as described before.

As the glass substrate, soda lime glass may be used, for example.

The thickness of the silica coat layer is generally 10 to 30 nm, and it can be formed by, e.g., a sputtering method.

The conductive layer generally has transparency. The meaning of transparency should include the case that the conductive layer has a certain degree of transparency other than the case that the transmittance of light is high as 90 to 100% like a so-called transparent conductive layer. A transparent conductive layer is preferable because it performs sufficiently function as a display element.

The thickness of the conductive layer is generally 50 to 200 nm, more preferably 100 to 150 nm. Typically, it is an ITO film prepared by a D.C. sputtering method. In this explanation, the ITO film is used.

The conductive layer can generally be formed by a physical vapor phase epitaxial method (PVD) such as a vacuum deposition method, an ion plating method or the like.

Then, at Step S₂, a resist is patterned by a photolithographic process. Then, at Step S₃, the ITO film is etched, and at Step S₄, the resist is peeled off to thereby obtain an anode pattern 2a and a driving circuit connecting terminal 2b.

Any known resist may be used unless it is against the spirit of the present invention. For the etching, a mixed aqueous solution of hydrochloric acid and nitric acid can be used. In order to peel off the resist, any known parting agent may be used unless it is against the spirit of the present invention.

Thereafter, at Step S₅, a layer containing Mo or a Mo alloy, a layer comprising Al, an Al alloy, Ag or an Ag alloy and a layer containing Mo or a Mo alloy are formed in this order by, e.g., a D.C. sputtering method. The thus formed lamination layer of metal constitutes a supplementary wire 3 according to the present invention.

The lamination film of metal may be formed by a physical vapor phase epitaxial method (PVD) such as a vacuum deposition method, an ion plating method or the like or a plating method such as electrolytic plating, electroless plating or the like.

The thickness of the layer containing Mo or a Mo alloy is generally 50 to 200 nm, and the thickness of the layer comprising Al, an Al alloy, Ag or an Ag alloy is generally 200 to 400 nm. Use of the Mo alloy instead of Mo improves anti-corrosion characteristics. As the Mo alloy, a two component system such as Mo—W, Mo—Nb, Mo—V, Mo—Ta or the like is preferably used.

When pure Al is used for the layer comprising Al, an Al alloy, Ag or an Ag alloy, the temperature for forming the film is preferably 100° C. or less in order to control the occurrence of hillocks. When the Al alloy is used for the layer comprising Al, an Al alloy, Ag or an Ag alloy, Al—Nd is preferably used because lowering of the resistance can be achieved in curing. Further, Al—Si or a three-component system such as Al—Si—Cu or the like can be used.

Here, explanation will be made as to use of a combination of three layers comprising a Mo layer, an Al layer and a Mo layer.

Then, at Step S₆, the resist is patterned in a photolithographic process. At Step S₇, the lamination film of metal is etched. At Step S₈, the resist is peeled off. For the resist, any known resist may be used unless it is against the spirit of the present invention.

In the etching, an etching liquid composed of a mixed aqueous solution of phosphoric acid, acetic acid and nitric acid can be used. In order to peel off the resist, any known parting agent may be used unless it is against the spirit of the present invention.

The Mo layer and the Al layer can be etched all together by this etching liquid whereby a patterned cathode supplementary wire 3 is formed.

For the pattering process for the ITO film (Steps S₂ to S₄) and the patterning process for the lamination film of metal (Steps S₆ to S₈), it is possible to form sequentially the ITO film and the lamination film of metal by sputtering, and then patterning is conducted to the lamination film of metal and the ITO film in this order.

Then, at Step S₉, spin coating of, e.g., a photosensitive polyimide film as an insulation film is carried out. At Step S₁₀, pattering is carried out according to a photolithographic process. At Step S₁₁, the film is cured to thereby obtain an insulation film pattern 4 having apertures 4a for pixels at pixel portions as shown in FIGS. 1 and 2.

The film thickness of the insulation film pattern 4 after curing is generally about 1.0 μm.

When an aperture for a pixel is preferably about 300 μm×300 μm, the contact portion 4b between a cathode and a supplementary wire should be 200 μm×200 μm or less because there is no substantial effect to the size of the display element as a whole.

Then, at Step S₁₂, spin coating of, e.g., a photosensitive acrylic resin is carried out; patterning of the formed resin is carried out according to a photolithographic process followed by curing, whereby a pattern 5 for separating cathodes is formed.

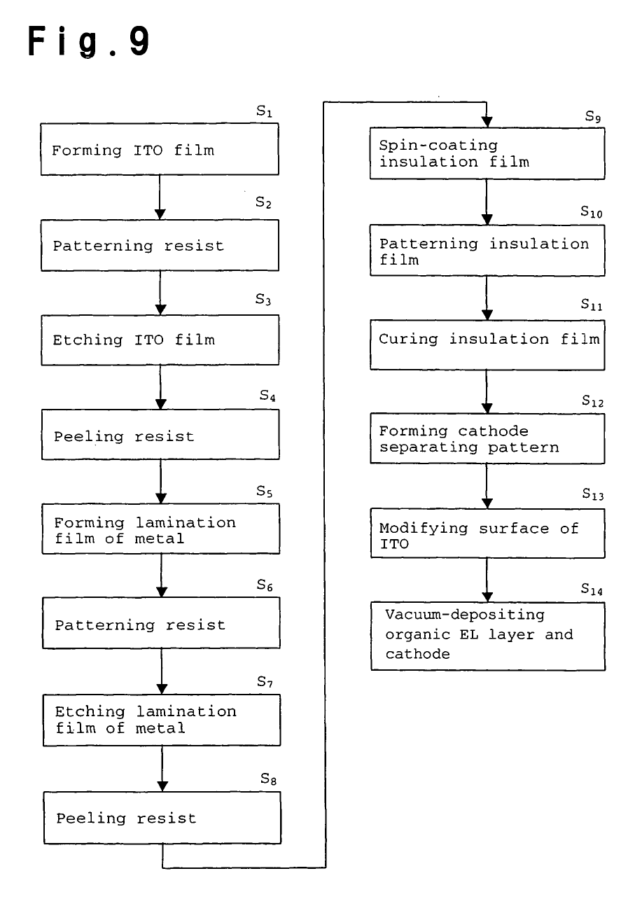

In forming such pattern, a negative type photosensitive resin is preferably used so as to provide a reverse taper structure. Use of the negative type photosensitive resin causes insufficient curing at a deeper position when light is irradiated from an upper side. As a result, the cross-sectional area of a lower portion of the cured portion is narrower than that of an upper portion of the cured portion in the view from the above. FIG. 10 shows the structure of the cured portion observed from a lateral side. Such structure is referred to as the reverse taper structure.

In such structure, when a mask for forming cathodes is formed by vacuum deposition in a later process, vacuum deposition does not reach a hidden portion 8 in the view from the above. Accordingly, it is possible to separate cathodes individually.

There is a case that the above-mentioned photosensitive polyimide resin and photosensitive acrylic resin are interchangeable from each other. Further, any known resin for the insulation film such as epoxy resin, phenol resin or the like can be used unless it is against the spirit of the present invention.

Then, at Step S₁₃, irradiation of oxygen plasma is carried out by using, e.g., a parallel plate type RF plasma (high frequency plasma) device to modify the surface of the ITO film. Then, at Step S₁₄, an organic EL layer and cathodes are formed by vapor deposition through the mask by using, e.g., a vapor deposition device. These cathodes correspond to the first conductive layer of the present invention.

The organic EL layer often comprises an interface layer, a hole transport layer, a light emitting layer, an electron injection layer and so on as structural elements. However, it may have a different layer structure. The thickness of the organic EL layer is generally 100 to 300 nm.

By forming the insulation film pattern, end portions of anodes 2a are covered with the insulation film. Accordingly, the surface of the organic EL layer in contact with the anodes 2a is flattened whereby a possibility of breaking of the organic EL layer or a cathode due to concentration of the electric field or the like can be reduced, and the withstand voltage of an anode and a cathode can be improved.

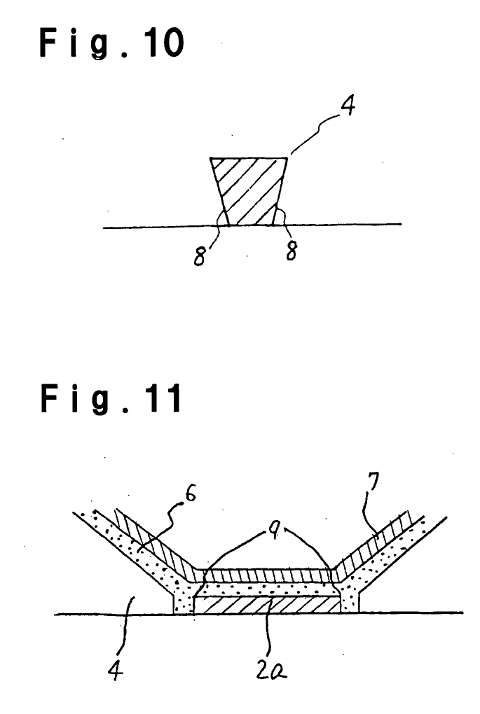

On the other hand, if edges 9 of an anode are in contact with the organic EL layer as shown in FIG. 11, there is a possibility of breaking of the organic EL layer or a cathode due to concentration of the electric field.

Al is often used for the cathode. However, alkali metal such as Li or the like or Ag, Ca, Mg, Y or In or an alloy containing it may be used instead of Al. The thickness of the cathode is generally 50 to 300 nm. It is preferable that the cathode preferably contains Al or an Al alloy in consideration of the contact characteristics to Mo or a Mo alloy.

Al or an Al alloy is generally easily oxidized. When a material constituting the supplementary wire is oxidized, there is a possibility of diffusion of oxygen in the oxide into Al or an Al alloy. However, it is supposed that an oxide produced on the surface of Mo or a Mo alloy prevents the migration of oxygen, and the oxide of Mo or the Mo alloy belongs to a good conductor.

It is not necessary that the entirety of a cathode comprises Al or an Al alloy but the portion of the conductive layer in contact with the supplementary wire may contain Al or an Al alloy.

Other than the above-mentioned method, the cathode may be formed by a physical vapor phase epitaxial method (PVD) such as sputtering, ion plating or the like.

Thus, a patterned organic EL 6 comprising the organic EL layer and a cathode pattern 7 are formed. Then, an organic EL display element provided with a cathode supplementary wire having a low resistance, a low contact resistance to an anode and a driving circuit connecting terminal and reliable contact characteristics, and an organic EL display device comprising such organic electroluminescence display element and a driving circuit for driving the display element can be obtained.

Specifically, low resistance characteristics can be achieved by the above-mentioned lamination film of metal. Further, the contact resistance between a driving circuit connecting terminal 2b and a cathode supplementary wire 3 and the contact resistance between a cathode pattern 7 and a cathode supplementary wire 3 can be maintained to a low resistance.

The present invention provides a large effect in case that the number of supplementary wires is at lest 30 whereby the electric power consumption is large and the degree of deterioration of the contact resistance is large as in a conventional organic EL display element.

In assuming a usual case that the pixel size is 300 μm×300 μm, the number of anodes is 100, the current efficiency is 1 cd/A and the luminance is 300 cd/m², the current flowing into cathodes exceeds 50 mA when the duty ratio is 1/30 and the number of cathodes is at least 30. Since the number of supplementary wires (the number of wiring) is the same as the number of cathodes, the current flowing into the supplementary wires exceeds 50 mA.

On the other hand, when a metallic material used conventionally for supplementary wires is Cr; the contact size is 200 μm×200 μm and the power consumption per 200 μm×200 μm exceeds about 200 mW, there would often occur the peeling-off or deterioration of the contact metal due to generated heat whereby the contact resistance may be deteriorated.

On the other hand, the contact resistance of the metallic material used conventionally for the supplementary wires is about 5Ω per 200 μm×200 μm under the above-mentioned conditions, and the power consumption becomes 250 mW.

Accordingly, the present invention using the supplementary wires having a low contact resistance and being capable of maintaining the low resistance value is particularly useful in such circumstances.

The constituent members used in the present invention, such as the conductive layer, organic EL layer, resist, parting agent, resin for the insulation film and so on may be known materials as described in, for instance, “Organic EL material and Display” (published by CMC Co., Ltd.) other than the above-mentioned materials, unless they are against the spirit of the present invention.

### EXAMPLES

In the following, several examples of the present invention will be described. Examples 1 and 2 are Examples.

### Example 1

An organic EL display element was prepared according to the above-mentioned explanation. The content of each process is the same as the above unless described specifically.

First, an ITO film of 150 nm was formed by a D.C. sputtering method on a silica coat layer of a soda lime glass substrate 1 of 0.7 mm having the silica coat layer of 20 nm formed by sputtering.

Then, patterning of a resist was carried out by a photolithographic process, and then, the ITO film was etched by using a mixed aqueous solution of hydrochloric acid and nitric acid, followed by peeling off the resist, whereby anode patterns 2a and driving circuit connecting terminals 2b were obtained.

As the resist, a phenol novolack resin was used, and monoethanol amine was used as the resist parting agent.

Then, a lamination film of metal comprising a Mo layer, an Al—Nd layer and a Mo layer in sequence was formed. In each film thickness of layers constituting the lamination film of metal, the lower Mo layer was 100 nm, the Al—Nd layer was 300 nm and the upper Mo layer was 100 nm.

Then, patterning of the resist was carried out by a photolithographic process. The lamination film of metal was etched by using an etching liquid composed of a mixed aqueous solution of phosphoric acid, acetic acid and nitric acid, and the resist was peeled off, whereby patterned cathode supplementary wires 3 were formed. As the resist, a phenol novolack resin was used, and as the resist parting agent, monoethanol amine was used.

Spin coating of a polyimide film was carried out to obtain an insulation film 4 having a thickness of 1.4 μm. patterning was conducted to the insulation film by a photolithographic process, followed by curing it at 320° C., whereby insulation film patterns 4 having apertures 4a for pixels corresponding to pixel portions were obtained as shown in FIGS. 1 and 2.

By conducting the curing, the resistance of the Al—Nd layer could be lowered. It is supposed that Nd moves to the grain boundary of Al by the heat of curing.

An aperture for a pixel was of 300 μm×300 μm and a contact portion 4b between a cathode and a supplementary wire was of 200 μm×200 μm.

The film thickness of the insulation film patterns 4 after curing was 1.0 μm.

Then, spin coating of a photosensitive acrylic resin was carried out, and then, patterning of the resin was carried out by a photolithographic process, followed by curing it at 200° C., whereby a pattern for separating cathodes 5 was obtained. A negative type photosensitive resin was used.

Thereafter, irradiation of oxygen plasma was conducted by using a parallel plate type RF plasma device to modify the surface of the ITO film. Then, an organic EL layer and cathodes were formed by vacuum deposition through a mask by using a vacuum deposition device.

Specifically, plasma processing of RIE (reactive ion etching) mode was carried out for 60 sec under plasma processing conditions of a flow rate of oxygen of 50 sccm (50 mL/min in a standard state), a total gas pressure of 6.7 Pa and 1.5 kW.

Then, an interface layer composed of copper phthalocyanine (hereinbelow, referred to as CuPc), a hole transport layer composed of N,N′-di(naphthalene-1-yl)-N,N′-diphenyl-benzidine (hereinbelow, referred to as α-NPD), a light emitting layer composed of Alq, an electron injection layer composed of LiF and cathodes of Al were formed to have 10 nm, 60 nm, 50 nm, 0.5 nm and 200 nm, respectively.

Among these, the interface layer of CuPc, the hole transport layer of α-NPD, the light emitting layer of Alq and the electron injection layer of LiF constitute the organic EL layer.

With respect to the hole transport layer, a triphenylamine type material such as triphenyldiamine (hereinbelow, referred to as TPD) can be used instead of α-NPD. Thus, patterned organic EL portions 6 comprising the organic EL layer and cathode patterns 7 were formed.

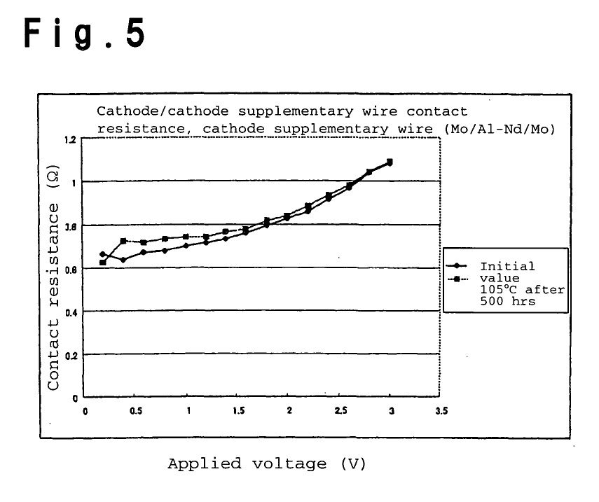

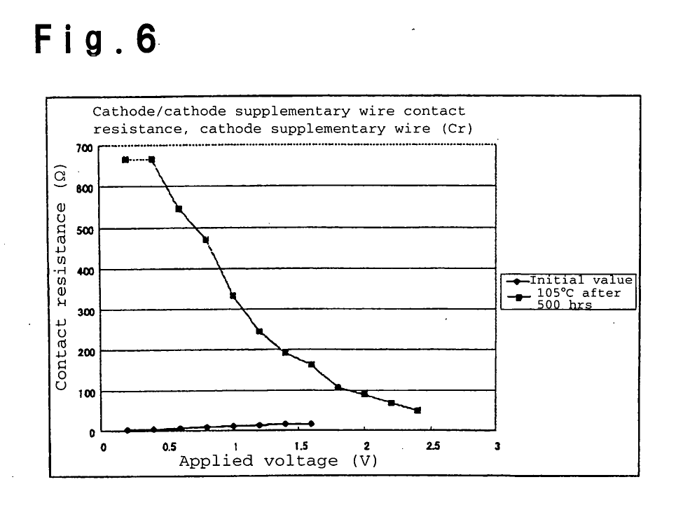

FIG. 5 shows contact characteristics of a cathode and a cathode supplementary wire of the element thus prepared. On the other hand, FIG. 6 shows contact characteristics between the cathode and the cathode supplementary wire in a case that Cr having a film thickness of 300 nm is used for the cathode supplementary wire. In FIGS. 5 and 6, contact resistances are resistance values per 200 μm×200 μm.

Comparison of FIG. 5 with FIG. 6 has revealed the following. When Cr is used for the cathode supplementary wire and it is kept at 105° C., the contact resistance increases remarkably. On the other hand, when the lamination film of metal comprising a Mo layer, an Al—Nd layer and a Mo layer (Mo/Al—Nd/Mo) is used, the contact resistance is low from the beginning and there is no deterioration even though it is kept at 105° C.

Further, since the specific resistance of Al—Nd of the cathode supplementary wire is about 4.5 μΩm, the resistance of the wire is suppressed to about ¼ in comparison with the case of using Cr under the condition that the film thickness is the same.

When a cathode supplementary wire having a layer containing Mo at its surface is used instead of the cathode supplementary wire of Cr, an oxidized layer is formed on the Mo surface. However, the above-mentioned difference is resulted because the oxidized Mo film is a good conductor and oxygen in the oxidized Mo film is prevented from diffusing into the material of the cathode. Thus, it can be considered that the cathode supplementary wire possesses stably low resistance contact characteristics when the Mo layer is formed at its front surface.

### Example 2

An organic EL display element was prepared according to the above-mentioned explanation, in the same manner as the case of Example 1. Contents of each process are the same as Example 1 unless specifically described.

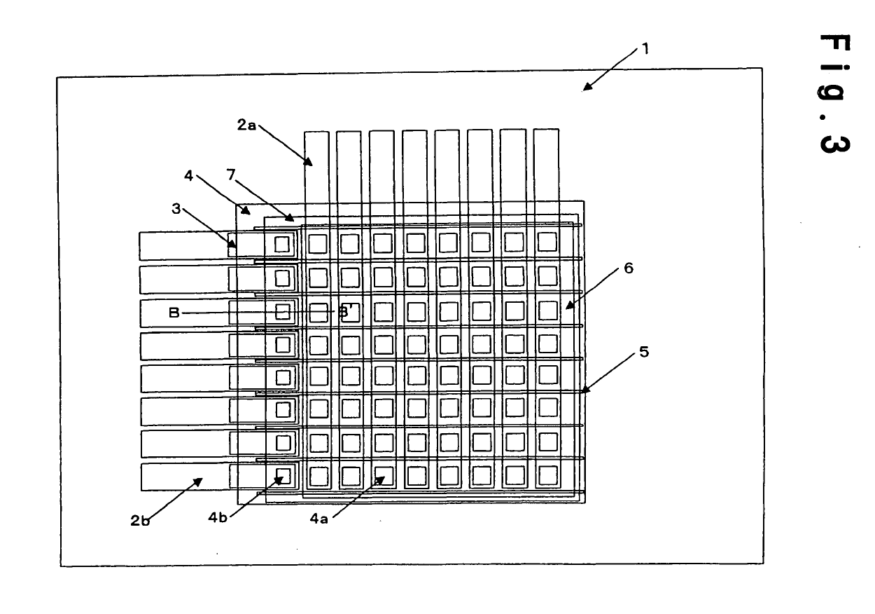

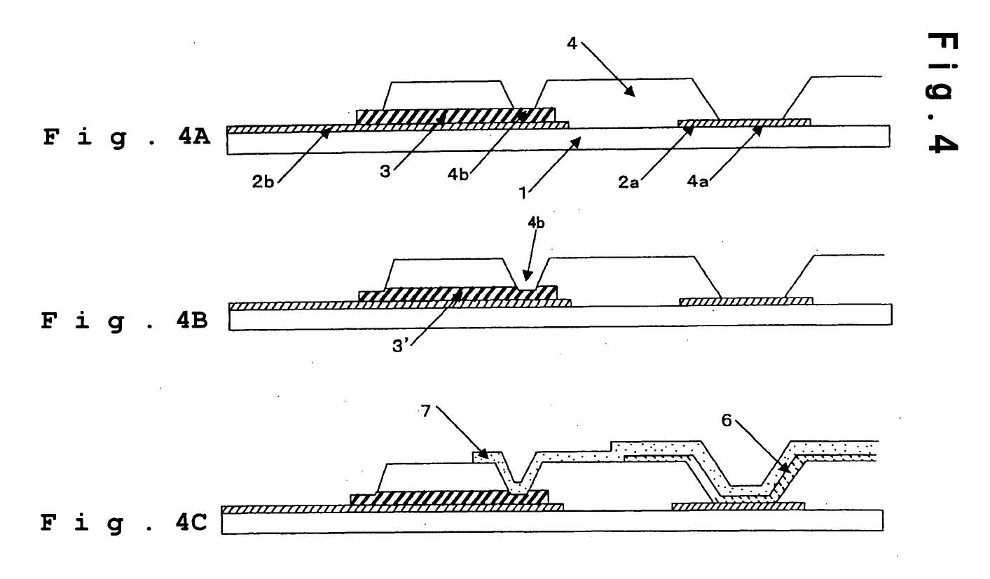

FIG. 3 is a plan view of the organic EL display element obtainable in Example 2. FIGS. 4A to 4C are cross-sectional views taken along B-B′ in FIG. 3, showing each process.

First, an ITO film of 150 nm was formed, and anode patterns 2a and driving circuit connecting terminals 2b were obtained in the same manner as Example 1.

Then, a lamination film of metal comprising a Mo—V layer, an Al—Nd layer and a Mo—V layer in sequence was formed by a D.C. sputtering method.

In the film thickness of the lamination film of metal, the lower Mo—V layer was 100 nm, the Al—Nd layer was 300 nm and the upper Mo—V layer was 100 nm in general thickness. The concentration of V in the Mo—V layer was 20 atomic % in order to assure anti-corrosion properties.

Then, pattering of the resist was carried out by a photolithographic process and the resist was peeled off in the same manner as Example 1. Mo—V and Al—Nd can be etched all together with an etching liquid. Thus, patterned cathode supplementary wires 3 were formed.

With respect to the patterning process to the ITO film and the pattering process to the metallic film, the ITO film and the metallic film can be formed in this order by sputtering, followed by pattering the metallic film and the ITO film sequentially.

Then, insulation film patterns 4 having apertures 4a for pixels were obtained in the same manner as Example 1. The insulation film patterns 4 were formed so that contact portions 4b for cathode supplementary wires were formed on the patterned cathode supplementary wires 3 as shown in FIG. 4A.

Thus, the insulation film patterns 4 define a surface area where cathodes contact cathode supplementary wires whereby fluctuation of the contact resistance between a cathode and a cathode supplementary wire can be reduced. Further, the resistance of Al—Nd can be reduced by the curing.

Then, a cathode separating pattern 5 was obtained in the same manner as Example 1. Then, organic EL layer portions and cathodes were formed by vacuum deposition.

In this Example, the surface of the Mo—V layer was cleaned beforehand because there is a case that a residue or the like produced at the time of developing the cathode separating layer remains on the surface of the Mo—V layer, or the surface of Mo—V is oxidized. By such cleaning treatment before the vacuum deposition of the cathodes, the contact resistance itself can be low, fluctuation of the contact resistance can be reduced and reliable contact characteristics can be maintained.

As a treatment before the vacuum deposition of the organic EL layer, dry etching may be conducted by using a mixed gas of oxygen and CF₄ enabling etching of the Mo—V layer. Then, it is possible to remove a contaminant on Mo—V and a part of the surface layer of Mo—V to thereby clean it.

Specifically, RIE mode dry etching was carried out for 40 sec under plasma processing conditions of a CF₄ flow rate of 50 sccm, an oxygen flow rate of 160 sccm, a total pressure of gas of 6.7 Pa and 1.5 kW.

Instead, a mixed gas of oxygen and SF₆ may be used. In either case, the film thickness of Mo—V layer to be removed is preferably smaller than the film thickness of Al for the cathode. Since the film thickness of Al for the cathode was 200 nm, the film thickness of the Mo—V surface layer to be removed was determined to be a preferred range of from about 30 to 40 nm.

Thus, the contact portion 4b of cathode supplementary wire was formed by etching.

FIG. 4B is a cross-sectional view taken along B-B′ in FIG. 3 after the surface portion of the Mo—V layer has been removed. FIG. 4B shows the contact portion 4b for the cathode supplementary wire, which is recessed by etching. Reference numeral 3′ in the same figure indicates that the patterned supplementary wire is partially etched.

Then, before the vacuum deposition of the organic EL layer and the cathodes through a mask, irradiation of oxygen plasma is carried out by using a parallel plate type RF plasma device to modify the surface of the ITO film, in the same manner as Example 1. However, the before-mentioned plasma processing can be used for these dual purposes because such treatment is rational.

Then, the patterned organic EL portions 6 comprising the organic EL layer and the cathode patterns 7 were formed in the same manner as Example 1 except that the irradiation of oxygen plasma was omitted. FIG. 4C shows how to.

Thus, the contact area between the cathode and the cathode supplementary wire is defined by the contact portion of cathode supplementary wire 4b in this embodiment. By this, the fluctuation of the contact area due to the positional fluctuation of the mask for vacuum-depositing the cathodes can be prevented.

The contact characteristics between a cathode and a cathode supplementary wire of the thus prepared element exhibited an excellent result as shown in FIG. 7.

When FIG. 7 is compared with FIG. 5, it is found that the initial value in FIG. 7 is far lower than that in FIG. 5 even in consideration of the difference between the Mo layer and the Mo—V layer and the difference of thicknesses, and the influence of an applicable voltage is also slight. Namely, it is found that the contact resistance in the case that the surface of the layer containing Mo or a Mo alloy is removed is low from the beginning in comparison with the case that it is not removed, and there is no deterioration of the contact resistance even though it is kept at 105° C.

This can be considered that a good contact resistance is obtainable by removing the layer containing Mo or a Mo alloy formed on the cathode supplementary wire by etching so that the cleaned layer containing Mo or the Mo alloy is connectable to a cathode.

### Example 3

An organic EL display element was prepared according to the above explanation, in the same manner as Example 1. Contents of each process are same as Example 1 except that a lamination layer of metal comprising a Mo—Nb layer, an Al—Nd layer and a Mo—Nb layer in sequence was formed by a D.C. sputtering method wherein in the thickness of constituent layers of the lamination film of metal, the lower Mo—Nb layer was 100 nm, the Al—Nd layer was 300 nm and the upper Mo—Nb layer was 100 nm instead of that the lamination film of metal comprising the Mo layer, the Al—Nd layer and the Mo layer in sequence was formed by the D.C. sputtering method wherein in the film thickness of constituent layers of the lamination film of metal, the lower Mo layer was 100 nm, the Al—Nd layer was 300 nm and the upper Mo layer was 100 nm.

The content of Nb in Mo—Nb was 10 atomic %. If the content of Nb exceeds 20 atomic % in the application of etching with an etching liquid composed of a mixed aqueous solution of phosphoric acid, acetic acid and nitric acid after the formation of the lamination film of metal by the D.C. sputtering method, the etching process is difficult. Accordingly, it should be 20 atomic % or less.

The contact characteristics between the cathode and the cathode supplementary wire of the thus formed element are the same as that of the case using the Mo layer, the Al—Nd layer and the Mo layer for the supplementary wire. However, when the structure described in this Example is applied to the supplementary wire, anti-corrosion properties to moisture in Mo can be improved remarkably, and reliability to the element can be improved. In order to improve the anti-corrosion properties to moisture, the content of Nb in Mo—Nb is preferably 5 atomic % or more.

Industrial Applicability

As described above, according to the present invention, an organic EL display element provided with a cathode supplementary wire wherein the wire itself has a low resistance, a low contact resistance to a cathode and a driving circuit connecting terminal can be maintained, and reliable contact characteristics can be presented, an organic EL display device and a manufacturing technique for such organic EL display element can be provided.

The present invention is useful for an organic EL display element or an organic EL display device usable for an information display panel, a instrument panel for a vehicle, a display for displaying dynamic pictures or still pictures, and so on, home electric appliances, vehicles, electric equipment for two-wheel vehicles and so on.

The entire disclosures of Japanese Patent Application No. 2002-109682 filed on Apr. 11, 2002 and Japanese Patent Application No. 2002-252296 filed on Aug. 30, 2002 including specifications, claims, drawings and summaries are incorporated herein by reference in their entireties.

What is claimed is:

1. An organic electroluminescence display element comprising a first conductive layer, a second conductive layer opposed to the first conductive layer, a driving circuit connecting terminal connected electrically to the first conductive layer via a supplementary wire and an organic electroluminescence layer disposed between the first conductive layer and the second conductive layer, wherein the supplementary wire has at least one surface layer as a layer containing Mo or a Mo alloy.

2. The organic electroluminescence display element according to claim 1, wherein the first conductive layer is connected to the layer containing Mo or a Mo alloy.

3. The organic electroluminescence display element according to claim 1, wherein the second conductive layer is made of ITO.

4. The organic electroluminescence display element according to claim 1, wherein the supplementary wire has a layer made of Al, an Al alloy, Ag or an Ag alloy.

5. The organic electroluminescence display element according to claim 1, wherein the first conductive layer is connected to an etched surface of the layer containing Mo or a Mo alloy.

6. The organic electroluminescence display element according to claim 1, wherein the portion connected to the layer containing Mo or a Mo alloy, of the first conductive layer is defined by an insulation film.

7. The organic electroluminescence display element according to claim 1, wherein the Mo alloy contains Nb.

8. The organic electroluminescence display element according to claim 7, wherein the content of Nb in the Mo alloy is 5 to 20 atomic %.

9. The organic electroluminescence display element according to claim 1, wherein the number of supplementary wires is at least 30.

10. The organic electroluminescence display element according to claim 1, wherein the portion connected to a supplementary wire, of the first conductive layer contains Al or an Al alloy.

11. An organic electroluminescence display element comprising a first conductive layer, a second conductive layer opposed to the first conductive layer, a driving circuit connecting terminal connected electrically to the first conductive layer via a supplementary wire and an organic electroluminescence layer disposed between the first conductive layer and the second conductive layer, wherein the supplementary wire comprises at least 3 layers including a layer containing Mo or a Mo alloy as a surface layer and a layer containing Al or an Al alloy formed below the surface layer.

12. An organic electroluminescence display device comprising the organic electroluminescence display element described in claim 1 and a driving circuit for driving the organic electroluminescence display element.

13. A method for producing an organic electroluminescence display element which comprises connecting electrically one of conductive layers formed by interposing an organic electroluminescence layer, to a driving circuit connecting terminal via a supplementary wire, wherein the connecting electrically includes a step of forming a layer containing Mo or a Mo alloy as the surface layer of the supplementary wire connected to the conductive layer and a step of etching the layer containing Mo or a Mo alloy by using gas containing at least CF₄ and oxygen or gas containing at least CF₆ and oxygen.
